(19) United States
(12) Patent Application Publication
(10) Pub. No.: US 2018/0018699 A1
(43) Pub. Date: Jan. 18, 2018

(54) MEDIA CONTROL METHOD AND SYSTEM

(71) Applicant: ONE WORLD LED PTY LTD, Edwardstown (AU)

(72) Inventors: Schumann RAFIZADEH, Edwardstown (AU); Tanami Dereck MULLER, Edwardstown (AU); Darius Sean RAFIZADEH, Edwardstown (AU); Benjamin Michael PETERSON, Edwardstown (AU)

(73) Assignee: ONE WORLD LED PTY LTD, Edwardstown (AU)

(21) Appl. No.: 15/648,018

(22) Filed: Jul. 12, 2017

(30) Foreign Application Priority Data
Jul. 12, 2016 (AU) 2016902736

(51) Int. Cl. G06Q 30/02; H04W 4/04; H04N 21/258

(52) U.S. Cl. CPC G06Q 30/0252; H04N 21/25841; H04W 4/04

(57) ABSTRACT

A method of providing media content to a target media device is disclosed. In one embodiment, the method includes obtaining ambient attribute information for at least one ambient attribute at the location of the target media device, selecting a media content item from at least one source of media content items according to a correlation between the ambient attribute information for the at least one ambient attribute and a set of ambient attribute selection conditions associated with the media content item and providing the selected media content item to the target media device for output and/or storage.

This application claims the benefit of Australian provisional patent application number 2016902736, filed on 12 Jul. 2016, the entire contents of which is herein incorporated by reference.

### INCORPORATION BY REFERENCE

The following patent applications are herein incorporated by reference in their entirety:
Chinese Patent Application No. ZL200710171787.8 titled “A Flash Array Device” in the name of One World Technology of Suzhou;
Chinese Patent Application No. ZL200810200121.5 titled “A Firmware Based Virtualization Platform” in the name of One World Technology of Suzhou;
Chinese Patent Application No. ZL201010149051.2 titled “A Device and Method of Firmware Based OS-independent Flash Array Management” One World Technology of Suzhou;
Chinese Patent Application No. ZL201010234704.7 titled “Flash cluster device and configuration method” in the name of One World Technology of Suzhou;
Chinese Patent Application No. ZL201020268635.7 “Flash Cluster Device”, in the name of One World Technology of Suzhou;
Chinese Patent Application No. ZL201010274777.9 titled “Flash Array Hub, Cascading Flash Array and Interleaving Cascaded Flash Array” in the name of One World Technology of Suzhou;
Chinese Patent Application No. ZL201110082382.3 titled “Method and System for Data Transmitting and Displaying” in the name of One World Technology of Suzhou;
Chinese Patent Application No. ZL201210015905.7 titled “Controlling Method and Device of Advertising Display” in the name of One World Technology of Suzhou;
Chinese Patent Application No. ZL201310560958.1 titled “Method and System for Accessing Data” in the name of One World Technology of Suzhou;
Chinese Patent Application No. ZL201410025236.0 titled “Method and Device for Setting Data display” in the name of One World Technology of Suzhou;
Chinese Patent Application No. ZL201410219695.2 titled “Method, Device and System of Data Processing” in the name of One World Technology of Suzhou; and
Chinese Patent Application No. ZL201510240289.9 titled “A Display Method and Device” in the name of One World Technology of Suzhou.

### TECHNICAL FIELD

The present disclosure relates to a media content control system, and a media distribution control method.

### BACKGROUND

The use of electronic media systems, such as electronic display systems, for communicating information content to the public, such as weather information, advertising information, news and the like is becoming increasingly widespread. For example, in modem cities, electronic displays such as large scale LED or LCD displays can be found placed in areas of congestion, such as malls, traffic intersections, airports and shopping centres.

Public information display systems may be used for digital out-of-home advertising which involves distributing advertising content for display at geographically distributed locations using individually addressable displays, such as kiosk based displays and electronic bill-boards. Such advertising of digital content may involve distributing advertising information according to a queue so as to display an advertisement in a pre-allocated time slot according to display criteria, such as, potential viewer concentration and advertising rate. For example, an advertisement may be queued for distribution and display during anticipated or historical peak periods of traffic congestion. Alternatively, an advertiser may elect to have an advertisement queued for distribution and display during known off-peak periods of traffic congestion to attract a lower advertising rate. Such advertising approaches are inflexible as they are restricted to presenting advertisements in the order set by the queue. Furthermore, in circumstances where the same advertising information is presented across multiple geographically distributed displays, information which may engage with a viewer at one location, but not be of interest or even relevant to a viewer at a second location.

Information display systems exist which provide improved flexibility to an extent by providing an ability to respond to and interact with a viewer based on queries, dialogs and user interactions or predetermined criteria. In information display systems of this type, a viewer is able to invoke a desired application and may either further narrow the available information, or search through it, by responding to queries and prompts presented by the information display system, such as via a user interface. However, information display systems of this type require a viewer to interact with the display, which may be inconvenient or in some cases, dissuade a viewer from accessing advertising information which would otherwise be relevant to them.

More recently, information display technology has focused on electronic connectivity with viewers by incorporating facial recognition and social media background data collection for smart marketing. However, such approaches are geared towards providing display content which is targeted for limited individual and/or social behaviour characteristics.

It would be desirable to provide an information media content distribution system which provides more engaging information with a population of users, such as media content distribution system involving multi-parties in real-time.

### SUMMARY

According to a first aspect of the present disclosure, there is provided a method of providing media content to a target media device, the method including:

obtaining ambient attribute information for at least one ambient attribute at the location of the target media device;

selecting a media content item from at least one source of media content items according to a correlation between the ambient attribute information for the at least one ambient attribute and a set of ambient attribute selection conditions associated with the media content item; and

providing the selected media content item to the target media device for output and/or storage.

In an embodiment, the at least one ambient attribute includes two or more of:

a. an environmental attribute;

b. a time-based attribute;

c. a geographical attribute;

d. a seasonal attribute;

e. a date-based attribute;

f. a cultural attribute;

g. a viewer behaviour attribute;

h. a traffic attribute; and

i. a local user attribute.

The ambient attribute information include may include one or more of:
a. ambient attribute information sensed at the location of the target output media; and
b. ambient attribute information determined and/or obtained based on the location of the target output media device.

Obtaining ambient attribute information for each of the at least one ambient attributes for the target media device may include sensing a value of an ambient attribute. In an embodiment which senses a value of an ambient attribute, obtaining ambient attribute information for each of the at least one ambient attributes may include obtaining a sensed ambient value and characterising the ambient attribute based on the sensed value. For example, in one embodiment, characterising an ambient temperature (that is, an ambient environmental attribute in the form of an ambient temperature attribute) based on a sensed temperature value includes assigning a category to each of plural predefined ranges of temperature values, and characterising the sensed ambient temperature value as the category of the predefined range of temperature values including the sensed temperature value. In this respect, in this specification the use of the term “correlation” is intended to refer to a relationship in which the at least one ambient attribute satisfies a respective set of ambient attribute selection condition. Such a relationship may exist, for example, when the obtained information for the at least one ambient attribute equates with a value, class, category or selection range defined by a respective set of ambient attribute selection conditions.

In an embodiment which determines and/or obtains ambient attribute information based on the location of the target output media device, such as a time-of-day attribute, the determined and/or obtained ambient attribute information include information which has been characterised based on a determined and/or obtained attribute value. For example, in one embodiment, characterising a time-of-day attribute based on an obtained current time-of-day value includes assigning a category to each of plural predefined ranges of time-of-day values, and characterising the current time-of-day value as the category of the predefined range of time-of-day value including the current time-of-day.

The set of ambient attribute selection conditions associated with a media content item may include a set of ambient attribute selection conditions for plural ambient attributes.

In an embodiment, the source of media content may include plural selectable media content items, such that each media content item has an associated set of ambient attribute selection conditions for plural ambient attributes. In such an embodiment, the selection of a media content item from the at least source of one media content items may be according to a correlation between the ambient attribute information for a selected two or more of the at least one ambient attributes and a set of ambient attribute selection conditions associated with the media content items includes determining and selecting the media content item having a set of ambient attribute conditions with the highest correlation with the ambient attribute information for the selected two or more of the at least one local ambient attributes.

In some embodiments, the at least one source of media content includes a media content database. Such a database may include, for example, indexable records associating each of plural media content items with a respective set of plural ambient selection conditions. The media content database may include a plurality of advertising media content files.

In some embodiments, selecting a media content item having the highest correlation with the ambient attribute information of a selected two or more of the at least one ambient attributes may include applying a ranking or weighting of ambient attributes. For example, in some embodiments, ambient attributes are ranked or weighted according to selection priority information.

Some embodiments may further include controlling operational characteristics of the target media device according to ambient attribute information for at least one of the ambient attributes. For example, in an embodiment in which the media device is a display device, display device or content characteristics such as brightness, grey scale, and colour temperature may be controlled according to according to ambient attribute information for one or more of the at least one ambient attributes.

A method according to an embodiment may further including receiving, at the target media device, ambient attribute information for one or more local ambient attributes sensed or determined for another of said media devices located at a different location, and using the received ambient attribute information to select the media content item.

According to another aspect of the disclosure there is provided a system for providing media to a target media device, the system including:

one or more content processors for obtaining ambient attribute information for at least one ambient attribute at the location of the target media device; and

at least one source of selectable media content items;

wherein the one or more content processors are operable to select a media content item from the at least one source of selectable media content items according to a correlation between the obtained ambient attribute information for the at least one ambient attribute and a set of ambient attribute selection conditions associated with each of the selectable media content items, and to communicate the selected media content item to the target media device.

Yet another aspect of the disclosure provides a media controller for communicating media content to each of a plurality of media devices in networked communication with the media controller, the media controller including:

one or more content processors for:
for a selection of the plurality of media devices, obtaining ambient attribute information for at least one ambient attribute at the location of each of the selected media devices;
indexing at least one source of selectable media content items to select, for each of the plurality of selected media devices, one or more media content items according to a correlation between the respective obtained ambient attribute information for the at least one ambient attributes and a set of ambient attribute selection conditions associated with each of the selectable media content items; and
communicating the respective selected media content item to the selected ones of the plurality of media devices.

Still another aspect of the present disclosure provides a media controller for communicating media content items to each of a plurality of media devices in networked communication with the media controller, the media controller including:

one or more content processors for:
receiving a set of ambient attribute conditions for a plurality of ambient attributes;
indexing at least one source of selectable media content items to select a media content item according to the received set of ambient attribute selection conditions; and
processing local ambient attribute information for each of the plurality of media output devices to identify one or more of the media devices having local ambient attributes having a correlation with the received set of ambient attribute selection conditions; and
communicating the respective selected media content item to each of the identified media devices.

Yet another aspect of the disclosure provides a media device, including:

means for obtaining ambient attribute information for at least one ambient attribute at the location of the media device; and

means for selecting a media content item from at least one source of media content items according to a correlation between the ambient attribute information for the at least one ambient attribute and a set of ambient attribute selection conditions associated with the media content items.

A particular advantage of embodiments is that they provide media content which depends on prevailing ambient conditions of the environment local to the target media device. Accordingly, embodiments may provide display media which is tailored for, and thus potentially more relevant to, the local environment of a viewer. In one form, embodiments may be used to provide display content in the form of advertising content having improved relevancy to the local ambient conditions. Such improved relevancy may allow for more effective advertising since the display content may be more engaging to a viewer.

### BRIEF DESCRIPTION OF DRAWINGS

Embodiments of the disclosure will now be described in further detail by reference to the attached drawings illustrating example form of embodiments of the disclosure. It is to be understood that the particularity of the drawings does not supersede the generality of the preceding description of the embodiments. In the drawings:

FIG. 1A is a block diagram of an electronic media system according to an embodiment;

FIG. 1B is a block diagram of an electronic media system according to another embodiment;

FIG. 2 is an example data structure for suitable for use with the system shown in FIGS. 1A and 1B;

FIG. 3 is an example data structure for suitable for use in combination with the data structure shown in FIG. 2;

FIG. 4 is a flow diagram of a method of selecting a media content item according to an embodiment;

FIG. 5 is a flow diagram of a method of selecting a media content item according to an embodiment;

FIG. 6 is a block diagram of an electronic media system according to another embodiment;

FIG. 7 is a network diagram for an embodiment of a media content distribution system incorporating a networked arrangement of electronic media systems of the type shown in FIG. 6;

FIG. 8 is a network diagram for another embodiment of a media content distribution system incorporating a networked arrangement of electronic media systems of the type shown in FIG. 6;

FIG. 9 is a network diagram for another embodiment of a media content distribution system incorporating a networked arrangement of electronic media systems of the type shown in FIG. 6;

FIG. 10 is a network diagram for another embodiment of a media content distribution system incorporating a networked arrangement of electronic media systems of the type shown in FIG. 6;

FIG. 11 is a network diagram for another embodiment of a media content distribution system incorporating a networked arrangement of electronic media systems of the type shown in FIG. 6;

FIG. 12 is a data structure relating ambient attribute conditions to control parameters for a media device according to an embodiment;

FIG. 13 is a network diagram for a media content distribution system according to an embodiment; and

FIG. 14 is a functional block diagram of an embodiment of a computing device suitable for use with a system in accordance with an embodiment.

### DESCRIPTION OF EMBODIMENTS

This disclosure relates to techniques for using ambient attribute information obtained for various ambient conditions in the environment of a user or viewer of a media device, such as time conditions, date conditions, temperature conditions, humidity conditions and ambient light conditions, to determine media content for providing to the media device based at least in part on the obtained ambient attribute information. Embodiments of the present disclosure may also control and/or adjust operating attributes of the media device according obtained ambient attribute information.

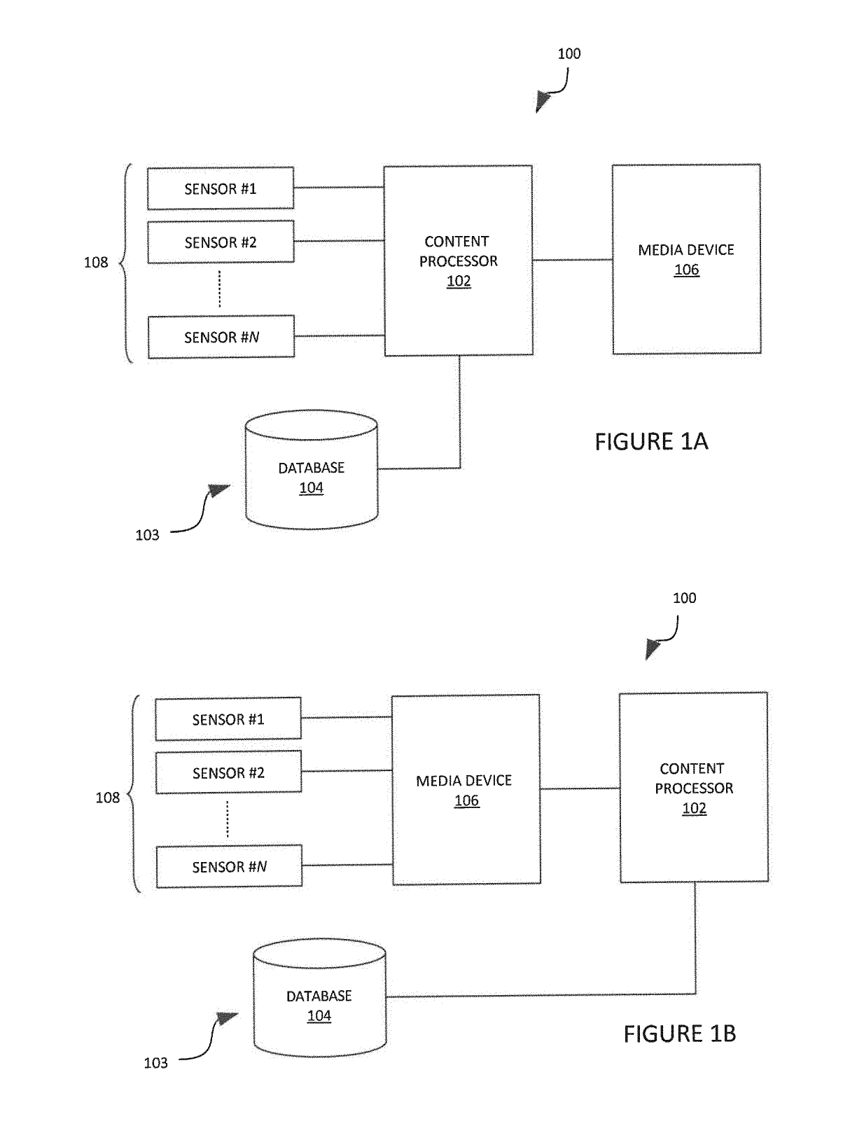

Turning initially to FIG. 1A and FIG. 1B there is illustrated an electronic media system 100 including a content processor 102, a source of media content items 103 (shown here as a database) 104, a media device 106, and one or more sensors 108 for providing ambient attribute information in the form of a sensed value of a respective ambient attribute. In the embodiments of the electronic media system 100 illustrated in FIGS. 1A and 1B, the content processor 102 may be any suitable type of processing device operative to perform processing operations, such as in response to executable instructions. The executable instructions may be stored on a computer readable medium, not expressly illustrated herein.

The content processor 102 may be a stand-alone processing component configured to perform processing operations or, alternatively, operations may be performed in a distributed processing environment. In the present example, the illustrated content processor 102 represents one or more physical components for performing processing operations as described herein. In this respect, the content processor 102 may be co-located with the media device 106 or it may be separate to the media device 106, but in data communication therewith via a suitable communication channel, such as a suitable data packet communications channel.

The source of media content items 103 may include any suitable data structure and/or content stored on a suitable memory storage device or devices capable of storing content therein. In the embodiments illustrated in FIG. 1A and FIG. 1B, the source of media content items 103 is a database 104 stored in a computer readable memory, such as a memory accessible to the content processor 102. However, it will be appreciated that other sources of media content items may be used. In the present case, the database 104 may include media content items such as images files and movies files that the content processor 102 can access and retrieve therefrom for providing to media device 106 for output and/or storage. As will be explained below, the database 104 may also include data structures which facilitate the selection of media content items according to ambient conditions at the location of the media device 106.

The database 104 may be configured to provide a data structure including configuration information defining rules or logic for selecting which of plural media content items is to be selected for providing to, or access by, the media device 106 for output and/or storage. In the embodiment illustrated in FIG. 1A, having obtained ambient attribute information in the form of one or more sensed values for a respective ambient attribute from one or more sensors 108, the content processor 102 indexes the obtained sensed value, or ambient attribute information determined from the obtained sensed value, into the database 104 to select a particular media content item for output on the media device 106. In this respect, a sensed value may include a discrete value, such as a discrete value of temperature, humidity, time, or light level; whereas ambient attribute information determined from a received sensed value may include a class or characterisation of a value for an ambient attribute such as light level (low, high), temperature (cold, warm, hot), traffic volume (low, medium or high), weather (sunny, cloudy, part cloudy), local daytime (morning, lunch, dinner, late night), weekday (holiday, weekend), season (Summer, Winter, Autumn, Spring),

Thus an aspect of the present disclosure involves selecting a media content item for providing to a target media device 106 for output and/or storage according to sensed values of ambient attributes, or ambient attribute information determined from one or more sensors located in proximity to the media device.

The media device 106 may include any suitable device capable of outputting media content. For example, the media device 106 may include a display device, an audio output device, an image projector, or a lighting system, such as a smart lighting system. A suitable display device may include any suitable indoor or outdoor display device, including but not limited to a LED display system, a LCD display system, or a plasma display system. Such a display device may have any suitable size, with its actual size depending on installation requirements. For example, in an outdoor area adjacent to a traffic intersection, the display device may be an electronic-bill board. The display device 106 may have the content processor 102 installed therewith or it may be located separately to the display device 106. In the context of this specification, a media device 106 intended to receive or provide media content for output may be referred to as a target media device.

The one or more sensors 108 may be any suitable type of sensor allowing for sensing ambient conditions. As described in further detail below, different sensors provide for sensing of different ambient conditions. Examples of suitable environmental sensors may include, but is not limited to, a temperature sensor, a light sensor, a humidity sensor, a rain sensor, a wind sensor. Other environmental sensors would be known to a skilled addressee. In the present case, each of the one or more sensors 108 communicates an analogue signal representing, or digital information encoding, a value for a respective sensed ambient attribute to the content processor 102 via a suitable communications interface, such as a wired or wireless communication interface. However, it is to be understood that other configurations are possible. For example, in relation to the embodiment shown in FIG. 1B, the sensors 108 communicate with or via the media device 106, also via a suitable communications interface. Suitable communications interfaces would be known to a skilled addressee. The sensed value of the ambient attribute information is then used by the content processor 102 to select a media content item from the database 104 for communication to, and output via, the media device 106.

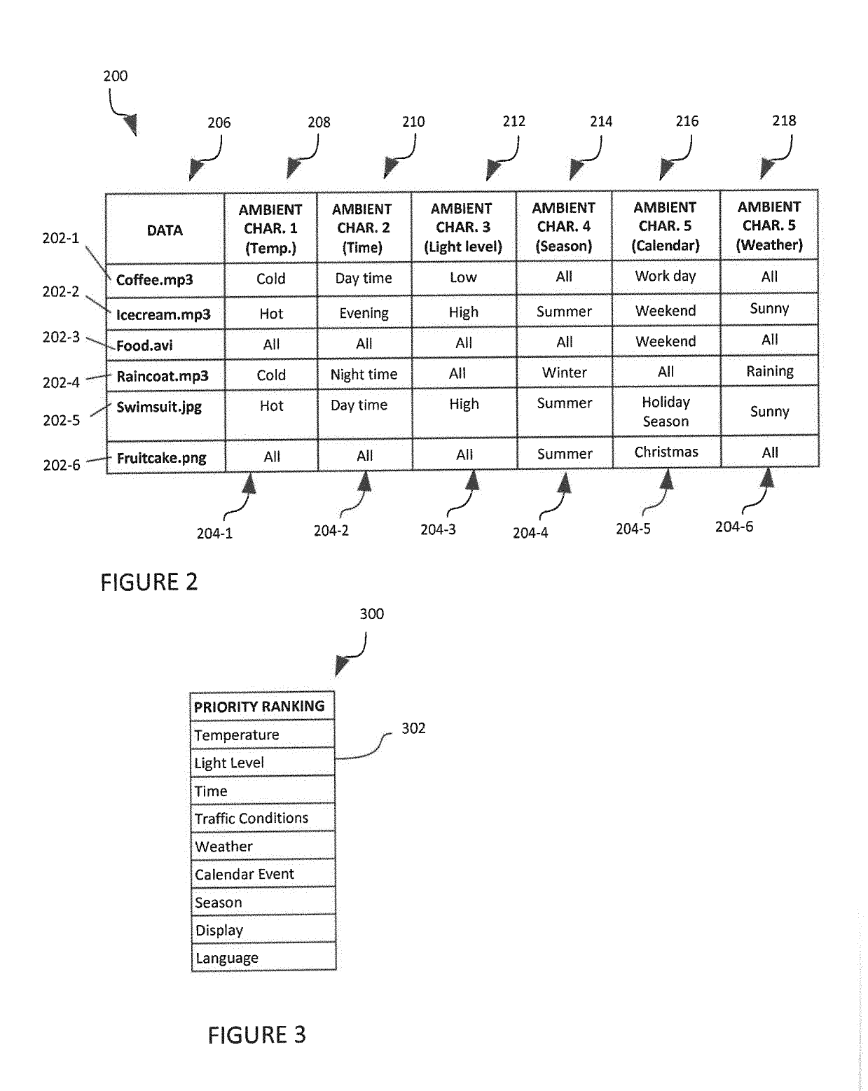

Turning now to FIG. 2 there is shown an example of a suitable data structure 200 for database 104 providing information defining rules, logic or conditions for selecting which of plural media content items is to be selected for providing to, or access by, the media device 106 for output. In the present case, data structure 200 contains plural media content items 202-1, 202-2, 202-3, 202-4, 202-5, 202-6. The plural media content items 202-1, 202-2, 202-3, 202-4, 202-5, 202-6 shown in FIG. 2 include image file types (for example, Joint Photographic Experts Group files and portable network graphics file types) and movie file type media content items (for example, Moving Picture Experts Group and audio video interleaved file types) media content items. However, it is to be appreciated that other types of media content items may be used.

The data structure 200 also includes, for each media content item, a set of ambient attribute selection conditions 204-1, 204-2, 204-3, 204-4, 204-5, 204-6 each of which is associated with a respective media content item 202-1, 202-2, 202-3, 202-4, 202-5, 202-6. In the present case, each set 204-1, 204-2, 204-3, 204-4, 204-5, 204-6 includes five ambient attribute selection conditions, namely, a temperature condition, 208 a time condition 210, a light level 212 condition, a season condition 214, a calendar condition 216, and a weather condition 218. However, it will be appreciated that a different number and/or type of ambient attribute selection conditions may be used. Furthermore, although in the present case the same set of ambient attribute selection conditions apply to each media content item, it is possible that a different number of, or indeed different ambient attribute selection conditions, may apply to each media data content item.

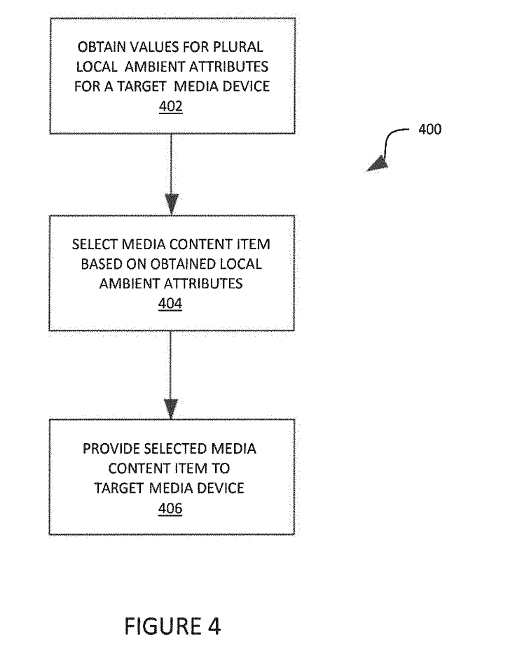

As shown in FIG. 3, the or another database 104 may also include a further data structure 300 including selection priority information in the form of a ranking 302 or weighting of ambient attributes. As will be explained in more detail below, the ranking 302 or weighting of ambient attributes may be used to prioritise the way in which the ambient attribute selection conditions are applied during the selection of a media content item such that a higher selection priority is given to media content items having an ambient selection condition which correlates with the highest priority ambient attribute first, and so forth moving down the list of prioritised ambient attributes. In the present example then, and with reference to FIG. 4, a media content item having temperature and lighting ambient attribute selection conditions which correlate with ambient attribute information obtained at step 402 (FIG. 4) would be selected at step 404 (ref. FIG. 4) for output at step 406 (ref. FIG. 4) in preference to a media content item including a set of ambient attribute selection conditions including selection condition having a correlation with received or determined temperature information only, and in preference to any media content item having a correlation with received or determined time of day and weather information, for example.

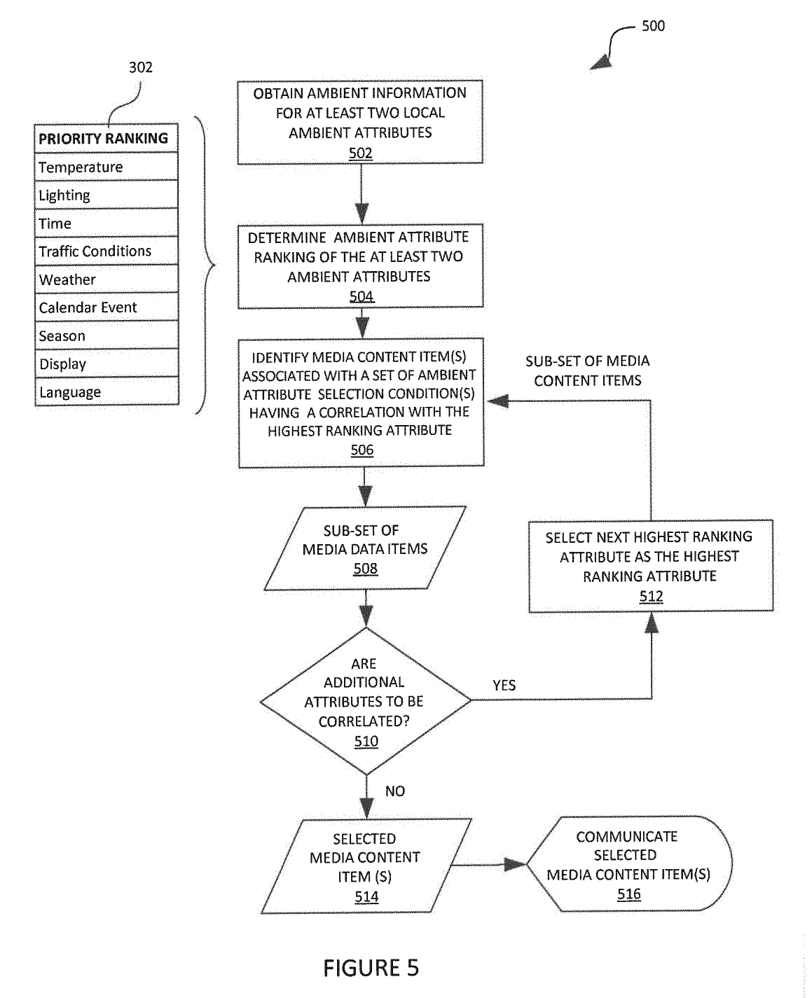

In relation to the example ranking 302 shown in FIG. 3, and with reference now to the flow diagram 500 shown in FIG. 5, applying the ranking 302 shown in FIG. 3 may involve initially identifying a sub-set 508 of one or more media content items which are determined, at step 504, as having an ambient temperature selection condition that best correlates with a current ambient temperature obtained at step 502 from ambient temperature information sensed or obtained from another information source. In the event that multiple media content items satisfy the highest priority ambient attribute selection condition (which in this example, is the ambient temperature selection condition), the media content item(s) of the sub-set of media content items identified at step 508 having ambient attribute selection conditions which correlate and/or satisfy both the sensed or otherwise provided ambient temperature information and the ambient lighting information would be prioritised for selection first, and so forth, moving down the raking 302.

In some embodiments, the content processor 102 may also process the sensed or determined ambient attribute information to set and/or adjusted the operational characteristics of the target media device 106. For example, in embodiments in which the media device 106 is a LED display, hardware characteristic such as LED screen brightness, colour temperature, fan speed may be set and/or adjusted according to ambient attribute information, such as, ambient attribute information in the form of one or more of the sensor ambient attribute values.

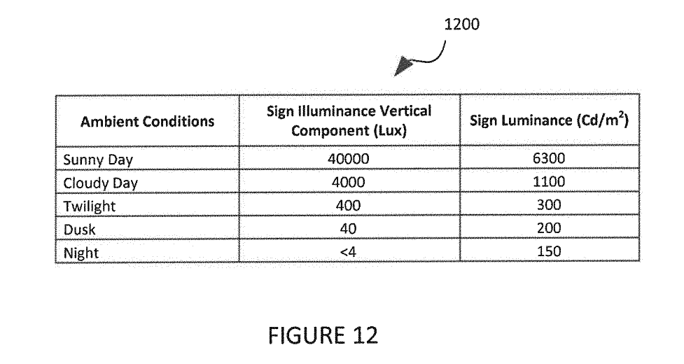

Furthermore, in some embodiments, processing the sensed or determined ambient attribute information to set and/or adjust the output characteristics of the media device 106 may provide for setting and/or adjusting the output characteristics of the target media device to comply with local regulations for different ambient requirements such as brightness, colour and wording. In this respect, FIG. 12 illustrates an example “brightness table” 1100 which may be implemented to satisfy a local regulation which may impose, for example, a restriction on illumination intensity for particular ambient lighting conditions at the location of the target media device.

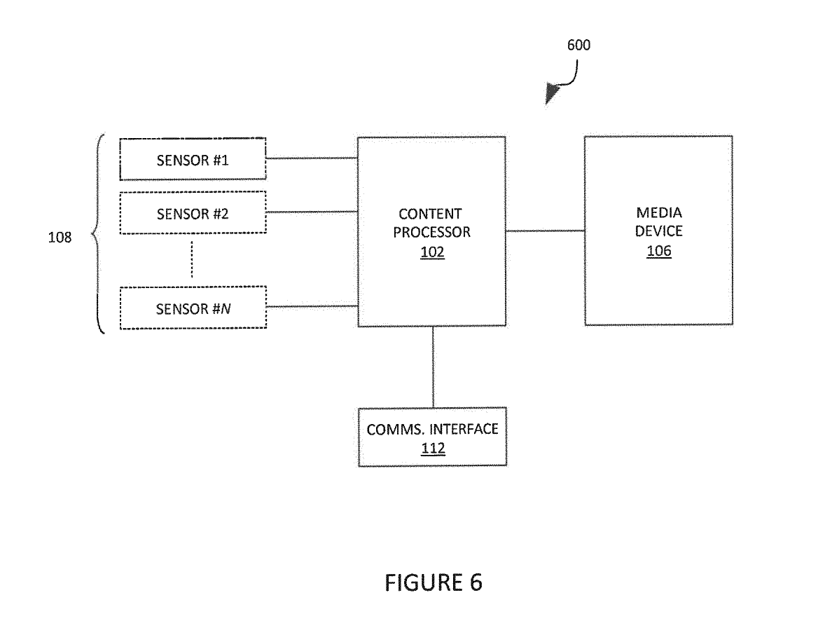

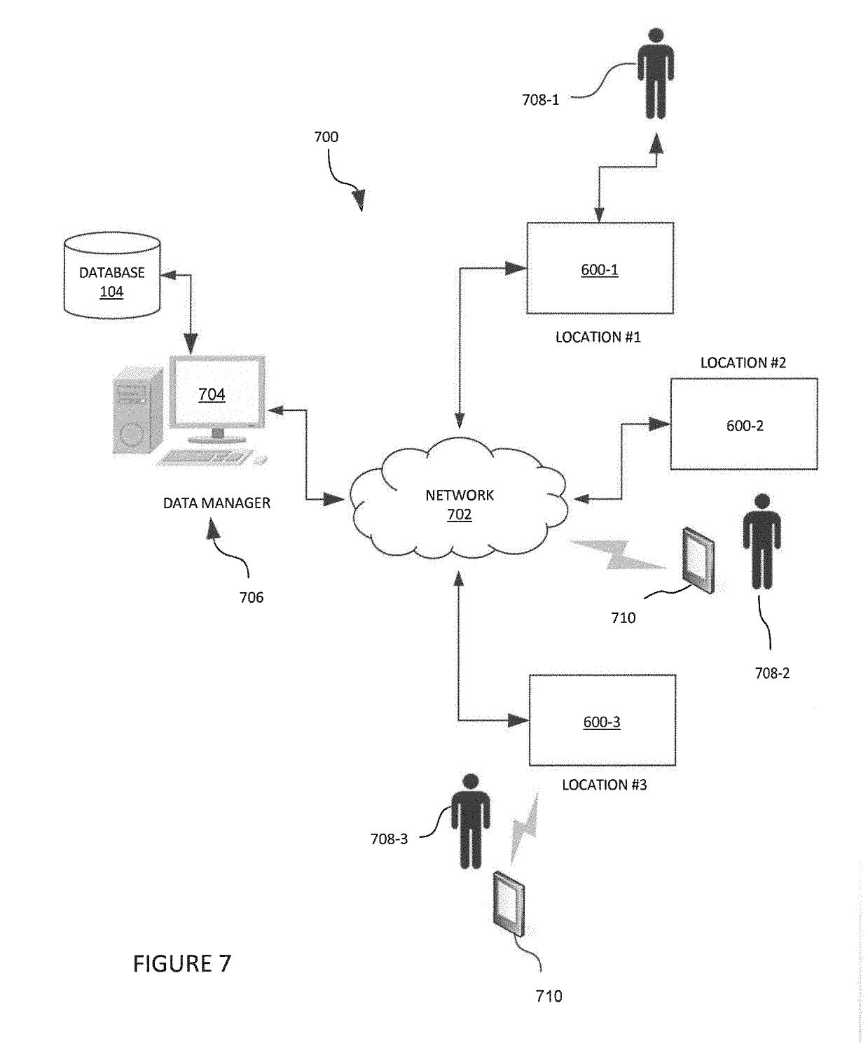

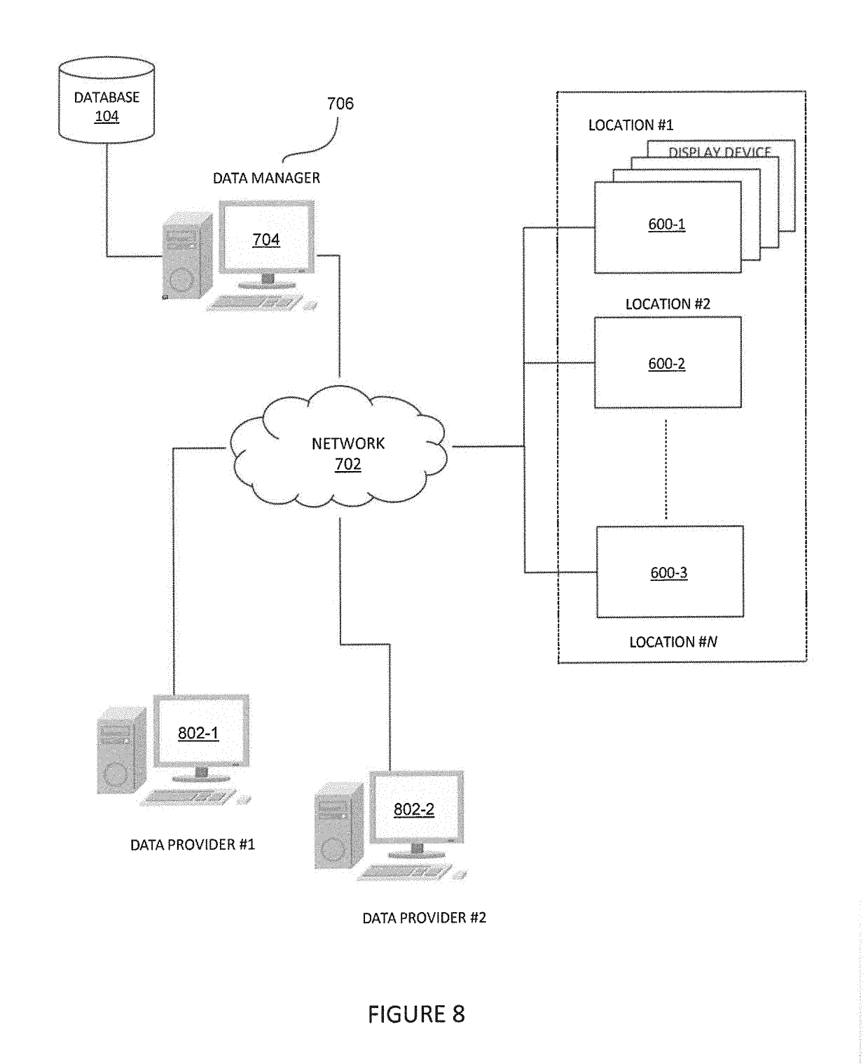

With reference now to FIG. 6 there is shown a block diagram of an electronic media system 600 according to another embodiment. The electronic media system 600 shown in FIG. 6 is similar to electronic media system 100 shown in FIG. 1A with the exception that the electronic media system 600 includes a data communications interface 112 for communicating with a communications network 702 (ref. FIG. 7) via a suitable communications channel for communicating sensor information and receiving media content items for output on the media device 106, such that the received media content items depend on the sensor information. In the present case, the one or more sensors 108 are depicted using dashed lines since the inclusion of the communications interface 112 enables sensor information to be received from external sensors via the communications interface 112, as will be explained further below. Accordingly, it is not essential that the electronic media system 600 shown in FIG. 6 include sensors 108.

The communications interface 112 may interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET, ADSL, SDSL), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the electronic media system 600 communicates with other computing devices via any type and/or form of gateway or tunnelling protocol such as Secure Socket Layer (SSL) or Transport Layer Security (TLS), or the Citrix Gateway Protocol.

The communications interface 112 may include a built-in network adapter, network interface card, PCMCIA network card, card bus network adapter, wireless network adapter, USB network adapter, modem or any other device suitable for interfacing the electronic media system 600 to any type of network capable of communication and performing the operations described herein. Communications network 702 (ref. FIG. 7) may include an IP based local (LAN) or wide area network (WAN). The communications network 702 may utilise wired or wireless communications channels. Suitable communications networks and channels would be known to a skilled person.

Accordingly, in the embodiment shown in FIG. 6, the electronic media system 600 may receive sensed ambient attribute information for one or more ambient attributes either from the one or more sensors 108 and/or via communications interface 112. Hence, although the embodiment illustrated in Figure includes sensors 108 for providing sensed ambient attribute information for one or more ambient attributes, it is not essential that the embodiment of the electronic media system 600 shown in FIG. 6 include such sensors 108. In some embodiments, information for one or more ambient attributes may be obtained from an external data source via the data communications interface 112. For example, in some embodiments, the content processor 102 may request and/or receive information for one or more ambient attributes from an external weather information service data provider, a traffic service data provider or the like, based on the geographical location of the electronic media system 600. Alternatively, in another embodiment, a remote content processor (not shown) requests and/or receives information for one or more ambient attributes from an obtained from an external data source and communicates a selected media content item to the electronic media system 600 via the data communications interface 112.

In the present case, the content processor 102 processes the received information for one or more ambient attributes and assembles an output message for data communication to a communications network 702 (ref. FIG. 7) via the data communications interface 112. In an embodiment, the output message encodes processed ambient attribute information and potentially additional information, such as information which either identifies, or which can be used to determine, the location of the electronic media system 600. Information which identifies, or which can be used to determine, the location of the electronic media system 600 may include an IP address (such as an IPv4 or IPv6 address) assigned to the electronic media system 600, GPS information obtained from a GPS sensor in communication with the content processor 102, or potentially manually entered geographical location information stored in the electronic media system 600. Alternatively, the electronic media system 600 may be assigned a unique identifier which is mapped to location information at a remote content processor, such as a content processor of a data management system 704 (ref. FIG. 7).

Turning now to FIG. 7 there is shown a block diagram of a media content distribution system 700 including a networked arrangement of electronic media systems 600-1, 600-2, 600-3 of the embodiment illustrated in FIG. 6. The media content distribution system 700 illustrated in FIG. 7 includes two parties, namely a data manager 706 and users 708-1, 708-2, 708-3 of the electronic media systems 600-1, 600-2, 600-3 respectively. The data manager 706 may include an entity which provides and/or maintains a source of media content items, such as database 104, and the associated sets of ambient selection conditions. For example, a data manager 706 may include an advertiser or an advertising service provider. In the context of this specification, a user 708-1, 708-2, 708-3 of an electronic media system 600-1, 600-2, 600-3 is any person who interacts with a respective one or more of the electronic media systems 600-1, 600-2, 600-3 at its respective location. A user interaction with an electronic media system 600-1, 600-2, 600-3 may include, for example, a user viewing and/or listening to a media content item output on the media device 106 of the electronic media systems 600-1, 600-2, 600-3.

As shown in FIG. 7, in some embodiments, user interaction with a media device of the electronic media systems 600-1, 600-2, 600-3 may include a user inputting or communicating information responsive to viewing and/or listening to a media content item output on the media device of the electronic media systems 600-1, 600-2, 600-3. For example, it is possible that such user information may be input or communicated directly to the electronic media systems 600-1, 600-2, 600-3, for example, via a keyboard, touch screen or pointing device, or, as shown in relation to electronic media systems 600-2, 600-3, by operating a user device 710 such as a mobile telephone, a tablet, a laptop, a smart watch or a vehicle based computer in data communication with the respective electronic media systems (shown here as electronic media systems 600-2 and 600-3) with which the user 708-1, 708-2, 708-3 is interacting, or with the or another communication network 702. User input information may be communicated to the data manager 706 for processing or indeed to another processing system in communication with the or another communication network 702. In embodiments, one or more user devices 710 may simultaneously connect or pair with the electronic media systems 600-1, 600-2, 600-3 locally, or indeed or remotely via the communications network 702. This allows multiple users (such as shoppers or viewers) to conduct transactions with the media content distribution system 700 for service and operation such as in a “virtual mall” application, responsive to media content items output on a target media device.

In some embodiments, a user device 710 may be operatively associated with the electronic media systems 600-1, 600-2, 600-3, or indeed with a communication network directly or indirectly in communication with the electronic media systems 600-1, 600-2, 600-3, such that the user device 710 may communicate user attributes stored on or otherwise accessible to the user device 710, such as a user's demographic (for example, a user's age, race, sex). These user attributes may be processed to assist with the selection of a media content items for output on the electronic media systems 600-1, 600-2, 600-3.

In the embodiment shown in FIG. 7, each electronic media system 600-1, 600-2, 600-3 is located at a different geographical location (eg. location #1, location #2, and location #3) and thus subject to different ambient conditions. For example, electronic media system 600-1 may be located in Adelaide, Australia, electronic media system 600-2 may be located in Beijing, China, and electronic media system 600-3 may be located in Johannesburg, South Africa. Alternatively, the different locations (eg. location #1, location #2, and location #3) may be different locations within a building or facility, such as an airport terminal, train station, sports stadium, shopping precinct, entertainment venue, office complex, or the like. In either case, since each electronic media system 600-1, 600-2, 600-3 is positioned at a different location, embodiments may select different media content items for providing to the respective electronic media systems 600-1, 600-2, 600-3 according to ambient attribute information sensed or otherwise obtained for the respective location of each electronic media system 600-1, 600-2, 600-3 based on a set of ambient attribute selection conditions.

As explained above the data manager 706 manages a source of media content items and the associated ambient attribute selection conditions on a database 104, or other suitable storage means. For example, a data manager 706 may input media content items into the database 104, or other suitable storage means, together with the associated ambient attribute selection conditions for each media content item. Inputting a media content item may include storing a file for a media content item in database 104, or entering a network address of a media content item, such as a Uniform Resource Locator (URL).

In some embodiments, the ambient attribute selection conditions may further include local and/or region specific geopolitical, customs, language, religious or legal selection conditions which apply to the location in which the electronic media system is located. In this way, for example, embodiments may allow for the selection of media content which complies with laws, language requirements, customs, religious considerations or the like which apply to the location of a target electronic media system.

In the embodiment illustrated in FIG. 7, in response to receiving, via the communications network 702, data communication encoding ambient attribute information, and potentially additional information, from a respective one of the electronic media systems 600-1, 600-2, 600-3, the data management system 704 retrieves from the database 104 or other suitable storage means, a media content item having ambient attribute selection conditions which correlate with the received ambient attribute information from the respective one of the electronic media systems 600-1, 600-2, 600-3. The selected media content item is then communicated to the respective one of the electronic media systems 600-1, 600-2, 600-3 from which the data communication encoding ambient attribute information, and potentially additional information, was received.

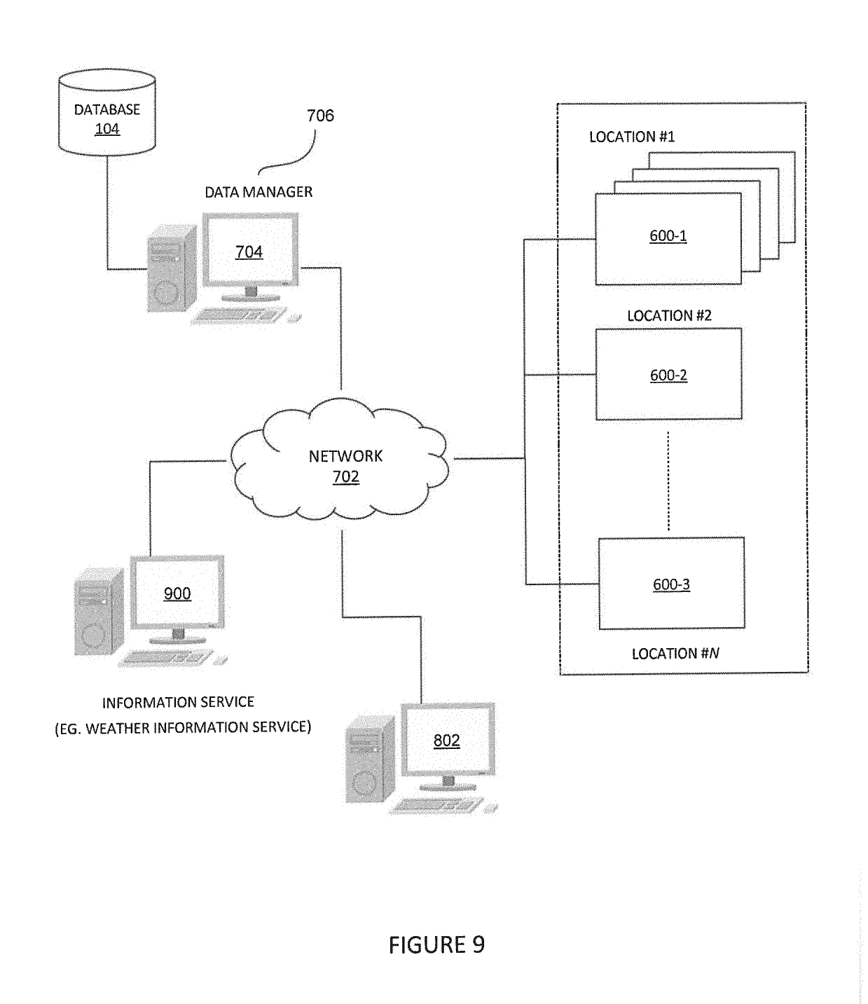

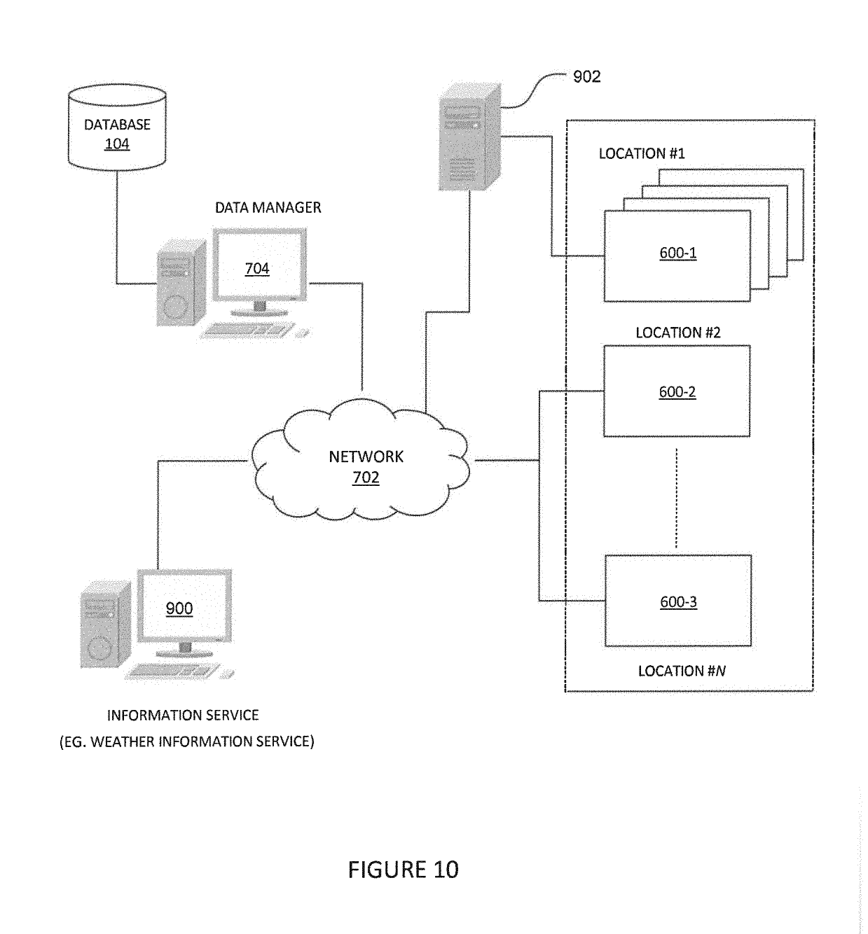

In an alternative embodiment, and such as shown in FIG. 9 and FIG. 10, it is possible that the data management system 704 is configured to retrieve information for one or more ambient attributes associated with the location of one or each of the electronic media systems 600-1, 600-2, 600-3 from a data source other than the electronic media systems 600-1, 600-2, 600-3. For example, it is possible that the data management system 704 may obtain location based information for one or more ambient attributes for the or each respective location of the electronic media systems 600-1, 600-2, 600-3 from an information service provider 900, such as a weather information service provider, a traffic information service provider or the like.

In the system depicted in FIG. 7, the media content distribution management system 700 thus selectively distributes selected media content items for output on a media device of a selected one of electronic media systems 600-1, 600-2, 600-3 according to information for one or more ambient attributes received via the communications network 702 by performing a pre-established procedure that results in the selection of a selected media content items according to selection conditions provided to the data management system 704 by the data manager 706 prior to the reception of the sensor information. The application of the ambient selection conditions may result in the assembly of an output communication, including the selected media content item, to a respective one of the electronic media systems 600-1, 600-2, 600-3 via the or another communications network 702 using an associated communications service which supports data communication.

The selection of the media content item by the data management system 704 may be performed using any suitable means and process. In the present case, data management system 704 is equipped with suitable software (not shown) to enable the data management system 704 to receive and process a data communication signal from the communications network 702 to identify the electronic media systems 600-1, 600-2, 600-3 sending the communication signal. In system embodiments that include plural electronic media systems 600-1, 600-2, 600-3, the data management system 704 may also decode the communication signal to identify the location of the electronic media systems 600-1, 600-2, 600-3 which was the source of the communications signal. Alternatively, the data management system 704 may access a data structure mapping the identity of an electronic media system with its location.

FIG. 8 shows a block diagram of another embodiment of a media content distribution management system 800 including a networked arrangement of electronic media systems 600-1, 600-2, 600-3. The embodiment illustrated in FIG. 8 also includes a data management system 704 configured to manage the configuration and/or operation of the electronic media systems 600-1, 600-2, 600-3 to allow operation of the electronic media systems 600-1, 600-2, 600-3 to support environmental sensors and data collectors to permit automatic collection of data in real-time for use to control the selection and distribution of media content items.

In the present case, electronic media systems 600-1 comprises plural such systems co-located in a local networked configuration located at, for example, a location such as a building, terminal, or shopping centre, whereas systems 600-2, 600-3 are located at separate geographical locations. Hence, in the embodiment shown in FIG. 8, each electronic media system 600-1, 600-2, 600-3 is located at a different geographical location (eg. location #1, location #2, and location #3) and thus subject to different ambient conditions. For example, electronic media systems 600-1 may be located in Adelaide, Australia, electronic media system 600-2 may be located in Beijing, China, and electronic media system 600-3 may be located in Johannesburg, South Africa. In this way, a media content item selected for output a first location (eg. location #1) may be different to a media content item selected for output a second location (eg. location #2), with the respective selected media content depending on the local ambient conditions at the first and second location respectively.

The system 800 shown in FIG. 8 stores sensor derived and local ambient condition information in a data structure in the data management system 704. The data management system 704 may thus provide a control platform for storage and update of sensor information, data structures/tables and standard interfaces. In some embodiments, the data management system 704 may provide a “soft-control panel” and an application programming interface (API) configured to operate in multiple modes, such as, a supervisor or privileged mode, and user or non-privileged modes, amongst other modes, so as to allow setup and dynamic update of local display/commerce factors. The display set up and contents selection may incorporate the previously described data structures.

During set up, each electronic media system 600-1, 600-2-600-3, is initialised with default data structures tables. On each system start up, the sensors are checked and data and values will be updated in real-time or as needed. These updated values may then be supplied to other parties in the network or may be used locally to select the best available media content item for output at the electronic media system 600-1, 600-2-600-3. In the case of an electronic media system 600-1, 600-2-600-3 including a media device in the form of a display, display attributes such as portrait/landscape, resolution, overlays, or brightness control schedule may be optimises to or maintain optimum display characteristic with respect to the local ambient conditions according to the ambient selection conditions and selection priority information.

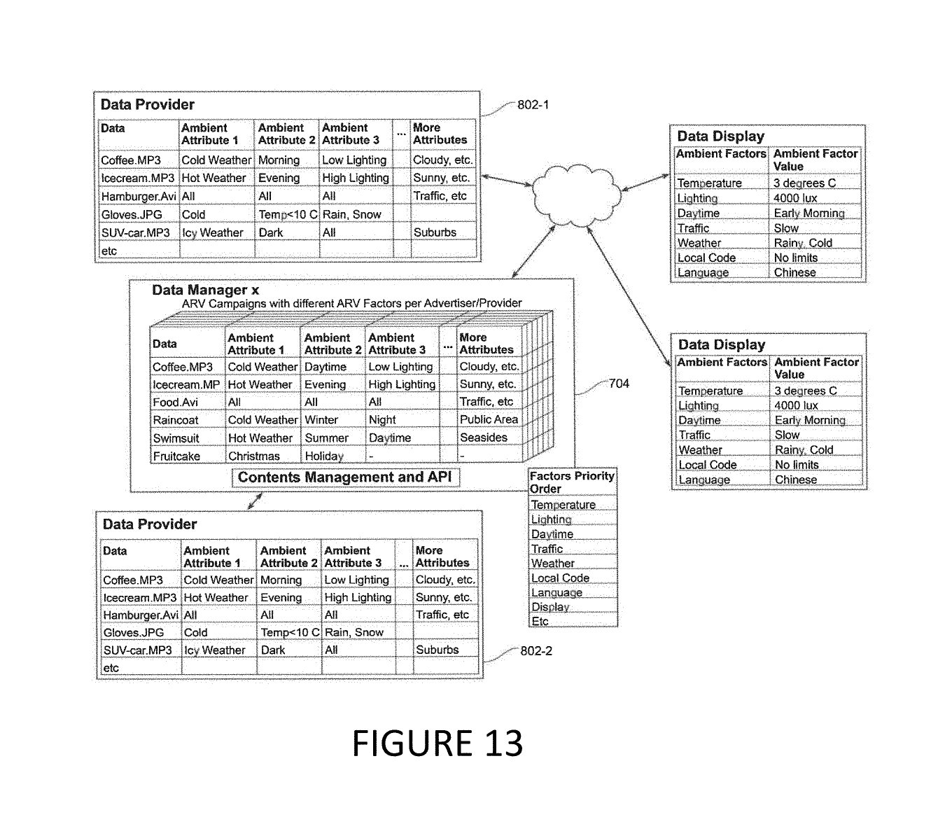

In an embodiment, the data structures including media content items and further data structures including selection priority information in the form of a ranking or weighting of ambient attributes for prioritising media content item selections may be stored and maintained by the electronic media systems 600-1, 600-2, 600-3 and shared with other parties such as the data management system 704 and/or data providers 802-1, 802-2, or indeed another of the electronic media systems 600-1, 600-2, 600-3. The data management system 704 shown in FIG. 13 stores data structures for a plurality of advertisement campaigns 1200, with each campaign being associated with a different data provider (shown as 802-1, 802-2). The data management system 704 will search the data base 104 of all campaigns 1200 for each data provider 802-1, 802-2, and select and optimize the best campaign 1200 for communication to each location based on that campaign's 1200 ambient attribute selection conditions versus local ambient attribute information, and according to selection priority information.

In one embodiment, the data management system 704 may use the selection priority information to select the media content items and supply them according to campaign schedules 1200 to the electronic media systems 600-1, 600-2, 600-3. In another embodiment, the electronic media systems 600-1, 600-2, 600-3 may request all campaigns 1200 and select a loop of media content items from the available campaign information which best correlates the ambient selection conditions according to selection priority information. In the former, the processing load is shifted to the electronic media systems 600-1, 600-2, 600-3 using more communication bandwidth and in latter the processing load is shifted to the data management system 704 and communication load is reduced. In an embodiment in which the data management system 704 is responsible for collecting data to select and transmit the campaigns 1200 to the electronic media systems 600-1, 600-2, 600-3, the collection of all data provider campaigns may require the maintenance and update of a central data base 104 as shown in FIG. 13.

In the embodiment illustrated in FIG. 8, the API manages communication of sensed or obtained ambient attribute information between data providers 802-1, 802-2 and the data management system 704. In this way, real-time information may be used to correlate and provide selected media content items to each electronic media system 600-1, 600-2, 600-3 that best reflects the respective location's local ambient conditions. Furthermore, in some embodiments, the data structures, such as data structures 200, 300 (ref. FIGS. 2 and 3), may be communicated between the networked elements, or updated periodically on demand using the API described above. Accordingly, the data manager 706, and/or data providers 802-1, 802-2 can review the ambient attributes for the different locations, and transmit the appropriate contents for display or presentation to each electronic media system 600-1, 600-2, 600-3 by correlating a media content item's ambient attribute selection conditions to the local ambient attributes.

FIGS. 9 to 11 show alternative embodiments of there is shown a block diagram of media content distribution systems including a networked arrangement of electronic media systems 600-1, 600-2, 600-3. In the embodiment depicted in FIG. 9, and as previously explained, an information service accessible to the data manager 704 via network 702 may provide ambient attribute information.

FIG. 10 shows an embodiment including a local content processor 902 in communication with electronic media system 600-1. The local content processor 902 may store the above described data structures and provide a selected media content item to output on the electronic media system 600-1 based on ambient attribute information and ambient attribute selection conditions included in the data structures. The stored data structures may be accessed for updating and/or modification by the data manager 704 via network 702. In the illustrated embodiment, the media content items may be stored on the local content processor 902, or they may be stored on the database 104 and communicated to the local processor 902 in response to a request from the local processor 902 responsive to sensed or otherwise obtained ambient attribute information.

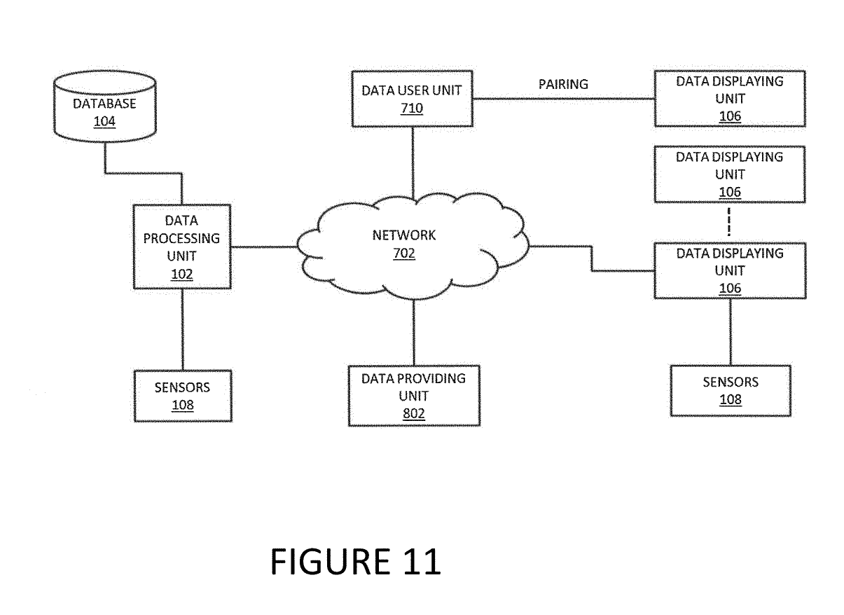

FIG. 11 shows an embodiment including in which the content processor 102 (labelled in FIG. 11 as “data processing unit”) is remote from but in communication with plural media devices 106 (labelled in FIG. 11 as “Data Displaying Unit”) via network 702. The embodiment shown in FIG. 11 is similar to embodiment shown in FIG. 7. In the embodiment illustrated in FIG. 11, one or more media content items may be selected for providing to one or more of the data displaying units 106 based on ambient attribute information sensed or otherwise obtained from sensors 108 in communication with a data displaying units 106 or in communication with the content processor 102. The selected at least one media content item may then be communicated to a data displaying units 106 via communications network 702 either directly, or via a data user device 710 in communication with the communications network 702 and a data displaying unit 106.

The operation of an embodiment will now be described in the context of the following example

### Example 1

Operation of an embodiment will now be described with reference to FIG. 2, FIG. 3 and FIG. 7 and further with reference to Table 1 (below) showing ambient attribute information obtained for electronic media systems 600-1, 600-2, 600-3 located at location #1, location #2, and location #3 respectively.

TABLE 1

| Location | Temperature | Light Level | Time |
|---|---|---|---|
| Location #1 | 45 degrees | High | 3:00 pm |
| | C (Hot) | | (Day/Afternoon) |
| Location #2 | −5 degrees | Low | 11:15 pm |
| | C (Cold) | | (Evening/Night) |
| Location #3 | 15 degrees | High | 9:10 am (Day/ |
| | C (Mid) | | Morning) |

### Location #1:

In the example shown in Table 1, and by applying the example priority selection information shown in FIG. 3, the “temperature” ambient attribute information is identified as having the highest selection priority, the “light level” ambient attribute as having the second highest priority, and the “time” ambient attribute as having the third highest selection priority.

Referring now to FIG. 2 and FIG. 7, in the present case, the system 700 processes the ambient attribute information for each of locations #1 to #3. In relation to location #1, processing of the respective ambient attribute information by the system 700 identifies four media content items as having a set of ambient attribute selection conditions including a temperature attribute selection condition 208 which is satisfied by the ambient temperature for location #1. Accordingly, the system 700 initially selects media content items “icecream.mp3”, “swimsuit.jpg”, “food.avi”, and “fruitcake.png” as a sub-set of the plural media content items available for selection.

Having, determined an initial selection based on the highest priority attribute, the system 700 then processes the next highest ranked ambient attribute, that is, “light level”. In this case, the light level ambient attribute for each of the sub-set of media content items, that is, “icecream.mp3” (ie. high) “food.avi” (ie. all), “swimsuit.jpg” (ie. high) and “fruitcake.png” (ie. all) correlate with the light level 212 ambient attribute selection condition and thus the selection process continues to the third ranked ambient attribute, “time”.

Finally, the system 700, compares the third ranked ambient attribute, that is, “time”, with the respective ambient attribute selection condition. In this example, that comparison determines that the “time” ambient attribute for “food.avi” (ie. all), “swimsuit.jpg” (ie. day time) and “fruitcake.png” (ie. all) correlates with the associated selection condition, that is “Day time”, whereas the ambient attribute for “icecream.mp3” does not. Hence, in this example, the media content items “food.avi” (ie. all), “swimsuit.jpg” (ie. day time) and “fruitcake.png” (ie. all) are provided to system 600-1 for output.

Table 2 shows the result of applying a similar approach to that described above for each of Locations #1 to #3.

TABLE 2

| | Temperature | Light | Level Time |
|---|---|---|---|
| Location | (1^{st} Priority Selection | (2^{nd} Priority Selection) | (3^{rd} Priority Selection) |
| Location #1 | Hot: | High: | Day/Afternoon: |
| | Icecream.mp3 | Icecream.mp3 | Swimsuit.jpg |
| | Swimsuit.jpg | Swimsuit.jpg | Fruitcake.png |
| | Fruitcake.png | Fruitcake.png | Food.avi |
| | Food.avi | Food.avi | |
| Location #2 | Cold: | Low: | Evening/Night: |
| | Coffee.mp3 | Coffee.mp3 | Raincoat.mp3 |
| | Raincoat.mp3 | Raincoat.mp3 | Fruitcake.png |
| | Fruitcake.png | Fruitcake.png | Food.avi |
| | Food.avi | Food.avi | |
| Location #3 | Mild: | High: | Day/Morning: |
| | Fruitcake.png | Fruitcake.png | Fruitcake.png |
| | Food.avi | Food.avi | Food.avi |

In view of the above, it will be appreciated that in an advertising application in particular, an advantage of an embodiment is that the sensed or obtained ambient attribute information may be used to triggering the selection and output of advertising media content items that are responsive to environmental conditions at the target media device.

Furthermore, embodiments may also improve the marketing and sales of products and service for data providers (such as product and/or service advertiser) in circumstances where, for example, the data providers or advertisers may not otherwise be able to track, maintain and/or update local conditions for each of several markets where they market or sell products; or in circumstances where a data provider sells seasonal products to various markets at different times of the year, or in circumstances where a data provider provides difference products to different market conditions at different times and seasons; or a data providers provides market or culturally sensitive products.

It is recognized by one skilled in the art, numerous elements known in the art have been omitted for clarity purposes only, for example a power source or connectivity components.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

In one form, an aspect of embodiments of the disclosure may comprise a computer program product for performing the method or operations presented herein. For example, such a computer program product may comprise a computer (or processor) readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

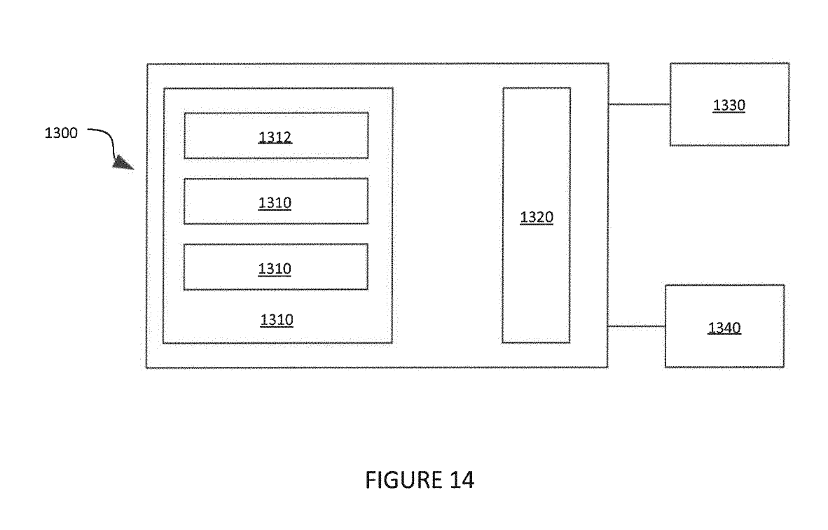

The computing elements of the media distribution system, such as the electronic media system, the data management system, or the data provider, may each be a computer implemented system comprising of a display device, a processor and a memory and an input device. The memory may comprise instructions to cause the processor to execute a method described herein. The processor memory and display device may be included in a standard computing device, such as a desktop computer, a portable computing device such as a laptop computer or tablet, or they may be included in a customised device or system. The computing device may be a unitary computing or programmable device, or a distributed device comprising several components operatively (or functionally) connected via wired or wireless connections. An embodiment of a computing device 1300 is illustrated in FIG. 14 and comprises a central processing unit (CPU) 1310, a memory 1320, a display apparatus 1330, and may include an input device 1340 such as keyboard, mouse, etc. The CPU 1310 comprises an Input/Output Interface 1312, an Arithmetic and Logic Unit (ALU) 1314 and a Control Unit and Program Counter element 1316 which is in communication with input and output devices (eg input device 1340 and display apparatus 1330) through the Input/Output Interface. The Input/Output Interface may comprise a network interface and/or communications module for communicating with an equivalent communications module in another device using a predefined communications protocol (e.g. Bluetooth, Zigbee, IEEE 802.15, IEEE 802.11, TCP/IP, UDP, etc). A graphical processing unit (GPU) may also be included. The display apparatus may comprise a flat screen display (eg LCD, LED, plasma, touch screen, etc), a projector, CRT, etc. The computing device may comprise a single CPU (core) or multiple CPU's (multiple core), or multiple processors. The computing device may use a parallel processor, a vector processor, or be a distributed computing device. The memory is operatively coupled to the processor(s) and may comprise RAM and ROM components, and may be provided within or external to the device. The memory may be used to store the operating system and additional software modules or instructions. The processor(s) may be configured to load and executed the software modules or instructions stored in the memory.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

1. A method of providing media content to a target media device, the method including:
obtaining ambient attribute information for at least one ambient attribute at the location of the target media device;
selecting a media content item from at least one source of media content items according to a correlation between the ambient attribute information for the at least one ambient attribute and a set of ambient attribute selection conditions associated with the media content item; and
providing the selected media content item to the target media device for output and/or storage.

2. A method according to claim 1 wherein the at least one ambient attribute includes two or more of:
a. an environmental attribute;
b. a time-based attribute;
c. a geographical attribute;
d. a seasonal attribute;
e. a date-based attribute;
f. a cultural attribute;
g. a viewer behaviour attribute;
h. a traffic attribute; and
i. one or more local user attributes.

3. A method according to claim 1 wherein the ambient attribute information includes one or more of:
a. ambient attribute information sensed at the target media device; and
b. ambient attribute information determined and/or obtained based on the location of the target media device.

4. A method according to claim 1 wherein selecting a media content item further includes applying priority selection information.

5. A method according to claim 1 further including controlling operational characteristics of the target media device according to ambient attribute information for the at least one ambient attribute.

6. A method according to claim 1 further including receiving, at the target media device, ambient attribute information obtained for one or more ambient attributes at the location of another of said target media devices, and using the received ambient attribute information as to select the media content item.

7. A method according to any one of claim 1 wherein the source of media content items includes a database storing plurality of advertising display files.

8. A method according to claim 1 wherein the ambient attribute information includes one or more of:
a. ambient attribute information sensed at the target media device; and
b. ambient attribute information determined and/or obtained based on the location of the target media device; and
wherein selecting a media content item further includes applying priority selection information comprising a ranking or weighting of ambient attributes, and wherein the selection of the media content item from the at least one source of media content items involves applying the priority selection information.

9. A system for providing media content to a target media device, the system including:
one or more content processors for obtaining ambient attribute information for at least one ambient attribute at a location of the target media device; and
at least one source of selectable media content items; and
wherein the one or more content processors are further operable to select a media content item from the at least one source of selectable media content items according to a correlation between the obtained ambient attribute information for the at least one ambient attribute and a set of ambient attribute selection conditions associated with each of the selectable media content items, and to communicate the selected media content item to the target media device.

10. A system according to claim 9 further including a data structure including selection priority information in the form of a ranking or weighting of ambient attributes for prioritising media content item selections, and wherein the one or more content processors are further operable to process the selection of the media content item by applying the priority selection information.

11. A media controller for communicating media content to each of a plurality of media devices in networked communication with the media controller, the media controller including:
one or more content processors for:
for a selection of the plurality of media devices, obtaining ambient attribute information for at least one ambient attribute at the location of each of the selected media devices;
indexing at least one source of selectable media content items to select, for each of the plurality of selected media devices, one or more media content items according to a correlation between the respective obtained ambient attribute information for the at least one ambient attribute and a set of ambient attribute selection conditions associated with each of the selectable media content items; and
communicating the respective selected media content item to the selected ones of the plurality of media devices.

12. A media controller according to claim 11, wherein the one or more content processors are configured to index a data structure including selection priority information in the form of a ranking or weighting of ambient attributes for prioritising media content item selections, and to to process the selection of the media content item by applying the priority selection information.

13. A media controller for communicating media content items to each of a plurality of media devices in networked communication with the media controller, the media controller including:
one or more content processors for:
receiving a set of ambient attribute conditions for a plurality of ambient attributes;
indexing at least one source of selectable media content items to select a media content item according to the received set of ambient attribute selection conditions;
processing local ambient attribute information for each of the plurality of media output devices to identify one or more of the media devices having local ambient attributes having a correlation with the received set of ambient attribute selection conditions; and
communicating the respective selected media content item to each of the identified media device.

14. A media device, including:
means for obtaining ambient attribute information for at least one ambient attribute at the location of the media device; and
means for selecting a media content item from at least one source of media content items according to a correlation between the ambient attribute information for the at least one ambient attribute and a set of ambient attribute selection conditions associated with the media content items.

15. A media device according to claim 14 further including means for obtaining selection priority information in the form of a ranking or weighting of ambient attributes for prioritising media content item selections, and processing the selection of the media content item by applying the priority selection information.

16. A computer readable media including a set of program instructions which are executable by one or more processors to perform a method according to claim 1.

17. A device for providing media content to a target media device, the device including:
a memory configured to store a set of media content items;
one or more processors configured to:
obtain ambient attribute information for at least one ambient attribute at the location of the target media device;
select a media content item from the set of media content items according to a correlation between the obtained ambient attribute information for the at least one ambient attribute and a set of ambient attribute selection conditions associated with the media content item; and
provide the selected media content item to the target media device for output and/or storage.

18. A device according to claim 17 wherein the one or more processors are further configured to:
obtain selection priority information in the form of a ranking or weighting of ambient attributes for prioritising media content item selections; and
select the media content item by applying the priority selection information.
